(19) United States
(12) Patent Application Publication
(10) Pub. No.: US 2025/0190103 A1
(43) Pub. Date: Jun. 12, 2025

(54) INFORMATION PROCESSING DEVICE AND NON-TRANSITORY, COMPUTER-READABLE RECORDING MEDIUM THEREFOR

(71) Applicant: Faurecia Clarion Electronics Co., Ltd., Saitama-shi (JP)

(72) Inventors: Kenta YASUTOMO, Saitama (JP); Keiichiro YOSHIHARA, Saitama (JP); Jun KAWANO, Saitama (JP); Takahiro UEMURA, Saitama (JP); Takuma SHIOGUCHI, Saitama (JP)

(21) Appl. No.: 18/955,055

(22) Filed: Nov. 21, 2024

(30) Foreign Application Priority Data
Dec. 12, 2023 (JP) 2023-209070

(51) Int. Cl. G06F 3/04883; G06F 3/0482; G06F 3/04845; G06F 3/0485

(52) U.S. Cl. CPC G06F 3/04883; G06F 3/0482; G06F 3/04845; G06F 3/0485

(57) ABSTRACT

An information processing device, including: an operator display control unit for respectively displaying, close to a first end of a screen and a second end of the screen opposite the first end, a plurality of a first operator corresponding to each of a plurality of objects displayed on the screen; and an object display control unit for moving a first of the objects corresponding to the first operators on which a first touch operation is performed closer to the first end when the first touch operation is performed on the first operator close to the first end, and moving the first object closer to the second end when the first touch operation is performed on the first operator close to the second end.

### TECHNICAL FIELD

The present disclosure relates to an information processing device and to a computer program.

### BACKGROUND

Display devices having large screens have come into practical use. For example, Patent Document 1 describes an information processing device that performs display control of this type of display device.

The information processing device described in Patent Document 1 changes the display range of an image in a screen region that displays the same image as that displayed in an electronic side mirror in response to a touch operation on the screen of a display device installed inside a vehicle cabin.
[Patent Document 1] JP 2022-11370 A

In Patent Document 1, the screen of the display device is sized to cover almost the entire dashboard. Therefore, for example, a driver sitting in the driver seat may have difficulty touching and operating an object displayed in the region of the screen close to the passenger seat because the finger of the driver cannot reach the object. As described above, there is room for improvement in Patent Document 1 in terms of improving the operability of touch operations on objects displayed in a screen region away from the user.

### SUMMARY

In consideration of the forgoing, an aspect of the present disclosure aims to provide an information processing device and a computer program that can improve the operability of a touch operation on objects displayed in a screen region away from the user.

An information processing device according to one embodiment of the present disclosure, including: an operator display control unit for respectively displaying, close to a first end of a screen and a second end of the screen opposite the first end, a plurality of a first operator corresponding to each of a plurality of objects displayed on the screen; and an object display control unit for moving a first of the objects corresponding to the first operators on which a first touch operation is performed closer to the first end when the first touch operation is performed on the first operator close to the first end, and moving the first object closer to the second end when the first touch operation is performed on the first operator close to the second end.

According to one embodiment of the present disclosure, an information processing device and a computer program are provided that can improve the operability of a touch operation on an object displayed in a screen region away from a user.

### BRIEF DESCRIPTION OF THE DRAWINGS

FIG. 1 is a diagram schematically illustrating a vehicle in which an in-vehicle system is installed according to an embodiment of the present disclosure;

FIG. 2 is a block diagram illustrating a hardware configuration of an in-vehicle system according to one embodiment of the present disclosure;

FIG. 3 is a diagram illustrating an example of a display screen displayed on a screen of a display unit according to an embodiment of the present disclosure;

FIG. 4 is a diagram illustrating an example of a display screen when a touch operation is performed on the screen illustrated in FIG. 3;

FIG. 5 is a diagram illustrating an example of a display screen when a touch operation is performed on the screen illustrated in FIG. 3;

FIG. 6 is a diagram illustrating an example of a display screen when a touch operation is performed on the screen illustrated in FIG. 3;

FIG. 7 is a diagram illustrating an example of a display screen displayed on a screen of a display unit according to one embodiment of the present disclosure;

FIG. 8 is a diagram illustrating an example of a display screen when a touch operation is performed on the screen illustrated in FIG. 7;

FIG. 9 is a diagram illustrating an example of a display screen when a touch operation is performed on the screen illustrated in FIG. 7;

FIG. 10 is a diagram illustrating an example of a display screen when a touch operation is performed on the screen illustrated in FIG. 9;

FIG. 11 is a flowchart illustrating a process executed by a control unit included in the in-vehicle system according to one embodiment of the present disclosure;

FIG. 12 is a subroutine of a first main process (step S103) of FIG. 11; and

FIG. 13 is a subroutine of a second main process (step S104) of FIG. 11.

### DETAILED DESCRIPTION OF EMBODIMENTS

The following description relates to an information processing device and a computer program stored on a non-transitory, computer-readable recording medium according to an embodiment of the present disclosure. Common or corresponding elements are marked with the same or similar reference codes, and duplicate descriptions are simplified or omitted as appropriate.

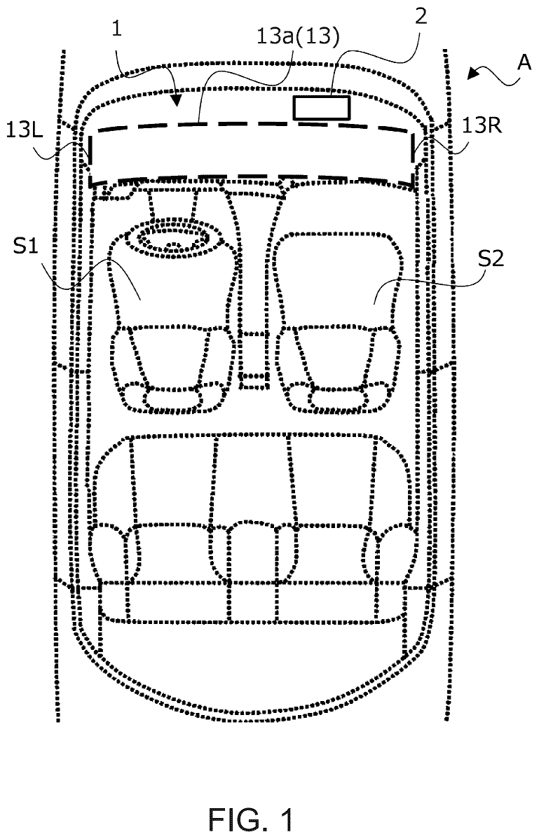

FIG. 1 is a diagram schematically illustrating a vehicle A in which is installed an in-vehicle system 1 according to an embodiment of the present disclosure. Vehicle A is one example of a moving body, and is a left-hand drive vehicle. Vehicle A may be a right-hand drive vehicle.

The in-vehicle system 1 includes, for example, a main unit 2 installed in a dashboard and a display unit 13 connected to the main unit 2. The screen 13a of the display unit 13 is sized to extend from close to the right front pillar to close to the left front pillar. The symbol 13R designates the right edge of the screen 13a located close to the right front pillar. The symbol 13L designates the left edge of the screen 13a located close to the left front pillar.

The left end 13L is an example of a first end of the screen. The right end 13R is one example of a second end of the screen that is opposite the first end of the screen.

In this manner, the display unit 13, which is one example of a display device, is installed inside the vehicle A. A row of seats including a driver's seat S1 (an example a first seat positioned close to the first end of the screen) and a passenger seat S2 (an example of a second seat positioned close to the second end of the screen) is installed inside the vehicle A. The screen 13a of the display unit 13 is positioned in front of the row of seats and is formed to extend in the vehicle width direction of the vehicle A.

Note that any reference to an element using a designation such as “first,” “second,” or the like as used in the present disclosure does not generally limit the quantity or order of those elements. These designations are used for convenience to distinguish between two or more elements. Thus, a reference to first and second elements does not mean, for example, that only two elements are employed or that the first element must precede the second element.

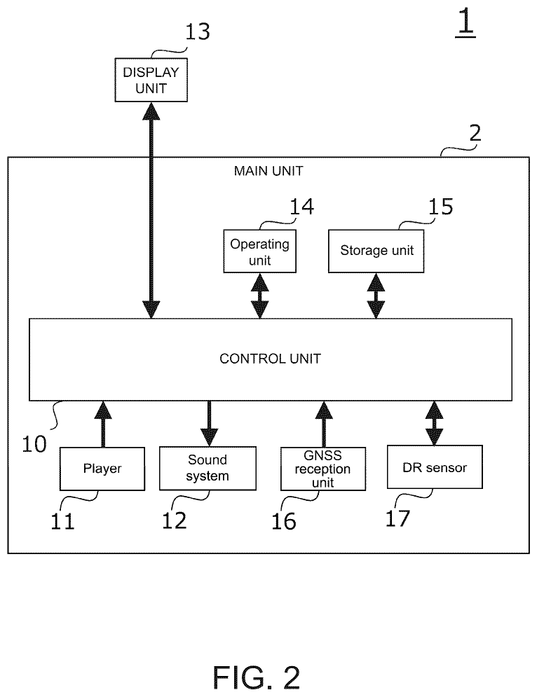

FIG. 2 is a block diagram illustrating a hardware configuration of an in-vehicle system 1 according to an embodiment of the present disclosure. The in-vehicle system 1 includes a main unit 2 (an example of an information processing device) connected to a touch-operable display device (display unit 13 in the present embodiment). The in-vehicle system 1 is equipped with various functions including, for example, an audio function and a navigation function. The in-vehicle system 1 may be a device that is a part of an IVI (In-Vehicle Infotainment) system.

As illustrated in FIG. 2, the main unit 2 includes a control unit 10, a player 11, a sound system 12, an operating unit 14, a storage unit 15, a Global Navigation Satellite System (GNSS) reception unit 16, and a Dead Reckoning (DR) sensor 17.

The main unit 2 may be configured to include only a part of structural elements (for example, the control unit 10 and the storage unit 15). In this case, other structural elements (such as the player 11) that are not included in the main unit 2 may be configured as units that are independent of the main unit 2. In addition, the main unit 2 may be configured as a single vehicle-mounted device that includes a display unit 13 in addition to the control unit 10, player 11, sound system 12, operating unit 14, storage unit 15, GNSS reception unit 16, and DR sensor 17.

Furthermore, the in-vehicle system 1 may include other components not illustrated in FIG. 2. In other words, there is a degree of freedom in the configuration of the in-vehicle system 1 and the main unit 2, and various design changes are possible.

The player 11 is connected to a sound source. The player 11 plays an audio signal input from the sound source, which is then output to the control unit 10.

Examples of the sound source include disc media such as compact discs (CDs) and Super Audio CDs (SACDs) on which digital audio data is stored, storage media such as hard disk drives (HDDs) and Universal Serial Bus (USB) memory, smartphones, tablet terminals, and servers that perform streaming via a network. When the sound source is streamed or when the sound source is stored in the memory unit 15 described later, the player 11 as individual hardware may be omitted.

The main unit 2 is an example of the information processing device according to one embodiment of the present disclosure, and is an example of a computer that executes an information processing method and an information processing program according to the present embodiment. That is, the information processing device according to the present embodiment is incorporated into the in-vehicle system 1 as the main unit 2.

The control unit 10 is configured, for example, as a large scale integration (LSI), and is provided with a central processing unit (CPU), a random access memory (RAM), a read only memory (ROM), and a digital signal processor (DSP).

The control unit 10 executes various programs developed in a work area of the RAM. As a result, the control unit 10 controls the operation of the in-vehicle system 1.

The control unit 10 is, for example, a single processor or a multiprocessor, and includes at least one processor. When configured to include a plurality of processors, the control unit 10 may be packaged as a single device, or may be configured as a plurality of devices that are physically separated within the in-vehicle system 1.

The control unit 10 processes a digital audio signal input from the player 11 or the memory unit 15, which is then output to the sound system 12.

The sound system 12 includes a D/A converter, amplifier, and the like. The audio signal is converted to an analog signal by the D/A converter. This analog signal is amplified by the amplifier and output to each speaker installed in a vehicle interior. As a result, music recorded in the sound source, for example, is played in the vehicle interior from each speaker.

The display unit 13 is a device that displays various screens and examples include displays configured of a liquid crystal display (LCD) or organic electro luminescence (EL). The display is equipped with a touch panel.

A user can perform various touch operations on the display (screen 13a), such as touch on (touching screen 13a using a finger), touch off (removing a finger from screen 13a), flick (flicking a finger across screen 13a), swipe (slide), drag, and drop.

The control unit 10 detects coordinates on the screen 13a at which a touch operation is performed, and executes a process associated with the detected coordinates.

In other words, the display unit 13 is an example of a touch-operable display device. In addition, the control unit 10 is connected to the display unit 13 which is an example of a display device.

The operating unit 14 includes mechanical operators such as switches, buttons, knobs, and wheels, that are mechanical systems, capacitance non-contact systems, membrane systems, or the like. Furthermore, the display unit 13 equipped with a touch panel display forms a part of the operating unit 14. A GUI on which touch-operable controls are arranged is displayed on a screen 13a of the display unit 13.

A user can operate the in-vehicle system 1 via mechanical controls or controls on the GUI (Graphical User Interface).

The storage unit 15 is an auxiliary storage device or a flash memory such as a hard disk drive (HDD) or solid state drive (SSD). Various programs such as an information processing program for executing the information processing method according to the present embodiment and various data such as map data for navigation are stored in the memory unit 15. In one example, the storage unit 15 includes a non-transitory, computer-readable recording medium having a computer program stored thereon that can be executed by an electronic processor of the information processing device. When the player 11 is omitted, sound source data is also stored in the storage unit 15.

The GNSS reception unit 16 measures the current position of the vehicle based on a GNSS signal received from a plurality of GNSS satellites. The GNSS reception unit 16 measures the current position at a predetermined time interval (for example, every second), and outputs the measurement result to the control unit 10. A representative example of GNSS is the Global Positioning System (GPS).

The control unit 10 renders the map data stored in the storage unit 15 to display the map on the screen 13a of the display unit 13, acquires the current position measured by the GNSS reception unit 16, and superimposes a mark indicating the vehicle position at the acquired current position, which is a position on a road on the map displayed on the screen 13a of the display unit 13 (map matching).

The DR sensor 17 includes various sensors such as a gyro sensor that measures an angular velocity related to a bearing in a horizontal plane of the vehicle and a vehicle speed sensor that detects a rotation speed of left and right driving wheels of the vehicle.

The control unit 10 may also estimate the current position from information acquired from the DR sensor 17. The control unit 10 may determine a final current position by comparing both the current position acquired from the GNSS reception unit 16 and the current position estimated based on the information acquired from the DR sensor 17.

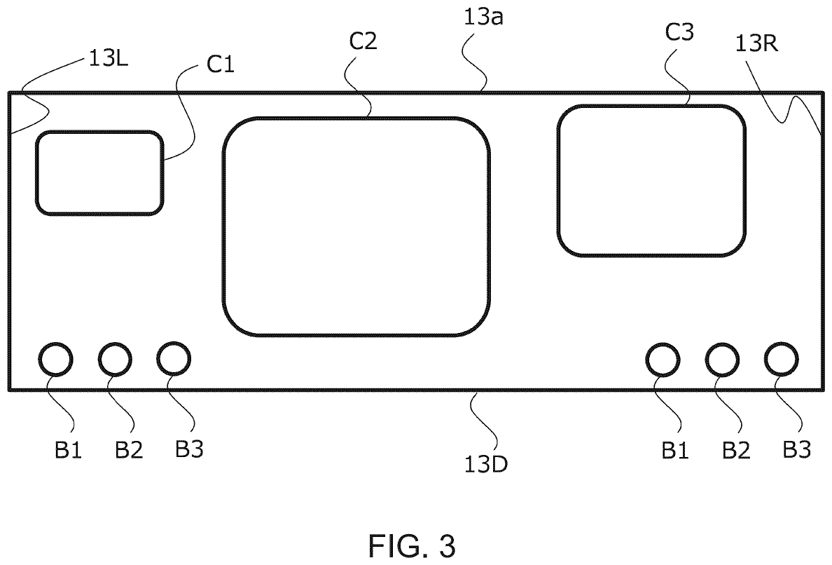

FIG. 3 illustrates an example of a display screen displayed on the screen 13a of the display unit 13. On the screen 13a, for example, a part of the plurality of objects arranged in virtual space are displayed. The virtual space is a two-dimensional virtual space or a three-dimensional virtual space.

The example of FIG. 3 displays a part of the object group, objects C1 to C3. For example, when the control unit 10 detects a flick operation, the control unit updates the area in the virtual space displayed on the screen 13a in accordance with the detected flick operation. This causes the object to be scrolled on the screen 13a. The objects displayed on the screen 13a change according to a scroll amount.

An object is a display on the screen 13a symbolizing an application type or a display that displays information processed by the application or this sort of information, and is variable in shape and size. Examples include widgets, icons, thumbnail images, pop-ups, lists, and information display windows. A widget is a display that includes interface components of a GUI (Graphical User Interface) and displays the results of processing by an application corresponding to that widget, and lays out a reception region for receiving instructions to be processed by that application. The object may be referred to by another name, such as content or the like.

The objects include, for example, objects that display information related to the navigation function, objects that display an overhead image of the vehicle when parking, objects for operating the audio functions installed in the in-vehicle system 1, objects for selecting radio stations, objects for adjusting the temperature and air volume of the air conditioner installed in the vehicle, and objects for displaying and setting various information related to the vehicle (for example, speedometer, tachometer).

In the example of FIG. 3, icons B1 to B3 are displayed close to the left end 13L of the screen 13a (close to the driver's seat S1 when a left-hand drive vehicle). The icons B1 to B3 are also displayed close to the right end 13R of the screen 13a (close to the passenger seat S2 when a left-hand drive vehicle). The icons B1 to B3 are displayed at positions adjacent to the edge of the screen 13a (a lower end 13D of the screen 13a here). Hereinafter, a left-hand drive vehicle will be described as an example.

The icons B1 to B3 close to the left end 13L are located close to the driver seat S1 and are difficult to reach from the passenger seat S2. Therefore, the icons B1 to B3 close to the left end 13L can be referred to as an operator for a user seated in the driver's seat S1 (hereinafter denoted “driver”). The icons B1 to B3 close to the right edge 13R are located close to the passenger seat S2 and are difficult to reach from the driver seat S1. Therefore, the icons B1 to B3 close to the right end 13R can be referred to as an operator for a user seated in the passenger seat S2 (hereinafter denoted “passenger”). For convenience, the icons B1 to B3 close to the left edge 13L will be referred to as “driver icons B1 to B3.” The icons B1 to B3 close to the right edge 13R are designated as “passenger icons B1 to B3.” When collectively referred to, the icons B1 to B3 are denoted “icons B”.

The icons B1 to B3 are operators corresponding to the objects C1 to C3, respectively. The icons B1 to B3 receive operations related to the corresponding objects C1 to C3, respectively.

When an object displayed on the screen 13a is changed in accordance with a screen scroll, icons B displayed on the screen 13a are switched to icons B corresponding to objects that are displayed following the screen scroll. As an example, when the object displayed on the screen 13a is changed to the objects C2 and C3 as well as to an object C4 (unillustrated) in accordance with the screen scroll, and the icon B displayed on the screen 13a is switched to an icon B4 corresponding to the icons B2 and B3 as well as to the object C4 (unillustrated).

The icons B are displayed in an alignment sequence corresponding to the objects displayed on the screen 13a. In the example in FIG. 3, the objects C1, C2, and C3 are displayed in sequence from the left end 13L side to the right end 13R side. Therefore, the icons B1, B2, and B3 corresponding thereto are displayed in sequence from the left end 13L side to the right end 13R side.

By making the alignment sequence of the icons B1 to B3 uniform with alignment sequence of the objects C1 to C3, the user readily grasps the correlated relationship between the icons B1 to B3 and the objects C1 to C3. Therefore, the operability is improved.

In the example of FIG. 3, the object C3 is located close to the right end 13R of the screen 13a. Therefore, it is difficult for a finger of the driver to reach the object C3. For the driver, it is not easy to operate the object C3. If the vehicle body vibrates while the vehicle is traveling, or if the object C3 requires precise operation, the difficulty of the operation further increases.

For example, the driver may conceivably perform a flick operation to move the object C3 close to the left end 13L, then operate the object C3. In this case, the driver needs to perform an appropriate flick operation so that the object C3 moves to a position where operation can be easily performed. However, in a situation such as while driving, it is desirable to keep the time that the driver looks at the screen 13a short. Therefore, it is desirable to provide a user interface that does not require such a flick operation.

Therefore, in the present embodiment, when a user (the driver, for example) touches any of the driver icons B1 to B3, an object corresponding to the touched driver icon B moves in the screen 13a so as to approach the left end 13L located close to the driver's seat S1. For example, by touching the driver icon B3 and moving the object C3 corresponding thereto to the left end 13L side, the driver can easily operate the object C3 displayed in the screen area where it is difficult for the finger to reach.

Furthermore, when the user (the passenger, for example) touches any of the passenger icons B1 to B3, an object corresponding to the touched passenger icon B moves in the screen 13a so as to approach the right end 13R located close to the passenger seat S2. For example, by touching the passenger icon B1 and moving the object C1 corresponding thereto to the right end 13R side, the driver can easily operate the object C1 displayed in the screen area where it is difficult for the finger to reach.

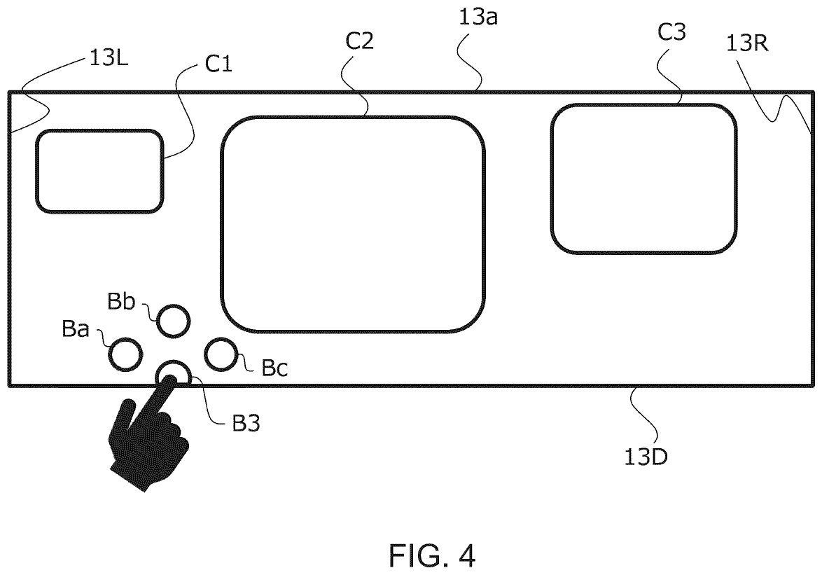

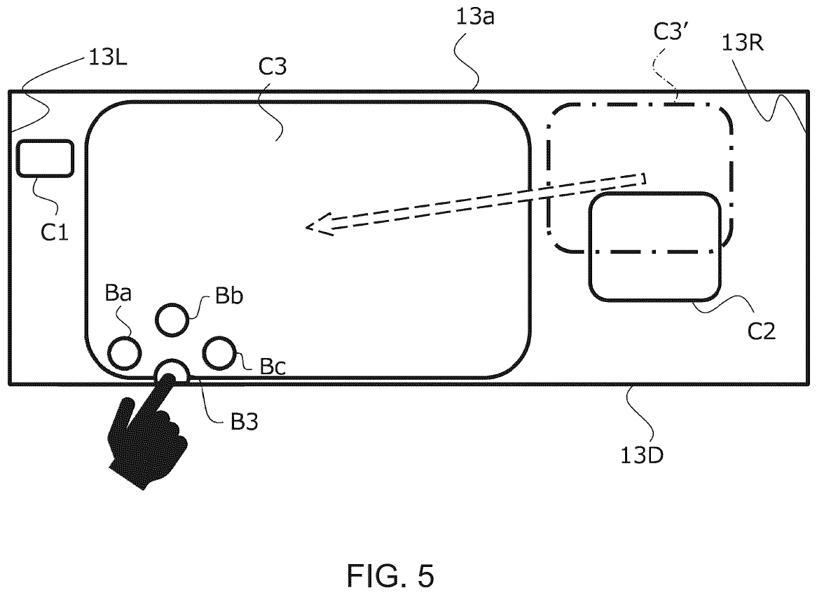

FIG. 4 and FIG. 5 illustrate examples of a display screen when a touch operation is performed on the screen 13a illustrated in FIG. 3. The hand illustrated in each of the figures illustrating display screen examples including FIG. 4 indicates the manner in which the user (the driver or passenger here) touches the screen 13a. Furthermore, an outline arrow illustrated using a dashed line indicates motion of a moving object or motion of a finger of the user performing a drag operation on the screen 13a.

As illustrated in FIG. 4, when the driver drags the driver icon B3 to the edge of the screen 13a (the lower end 13D of the screen 13a here), three sub-icons Ba to Bc are displayed at positions adjacent to the dragged driver icon B3. Along with the display of the sub-icons Ba to Bc, the display of icons B other than the driver icon B3 is removed. In another embodiment, the icons B other than the driver icon B3 may remain displayed without being removed.

Furthermore, as illustrated in FIG. 5, the object C3 corresponding to the driver icon B3 moves to the left end 13L side (outline arrow). In other words, the object C3, which is displayed at a position where it is difficult for the finger of the driver to reach, is moved to a position where it is easy for the finger of the driver to reach (close to the driver icon B3 here). Note that in FIG. 5, for convenience of description, the object C3 before movement is indicated by a dashed dotted line and indicated by the reference code C3′.

In addition, the object C3 is displayed enlarged compared to before the movement. Here, “enlarged” means that the display range of the object within the screen 13a is expanded. More specifically, “enlarged” includes raising a display magnification in accordance with expansion of the display range (for example, in a map image for navigation, enlarging a scale), increasing an amount of information displayed in accordance with expansion of the display range (for example, in a map image for navigation, expanding the display range of the map without changing the scale), and the like.

Note that enlargement of the object C3 is not essential. The object C3 may acceptably not be enlarged.

The objects C1 and C2 other than the object C3 that correspond to the touched driver icon B3 are evacuated to an empty space along with movement of the object C3.

The display range of the objects C1 and C2 after evacuation and the display range of the object C3 after the movement may overlap. In this case, for example, as illustrated in FIG. 5, the objects C1 and C2 are displayed shrunken compared to before the movement of the object C3. This ensures visibility of the object C3 after movement.

In another embodiment, in order to ensure visibility of the moved object C3, the objects C1 and C2 may be displayed behind the object C3.

The sub-icons Ba to Bc are icons used by the user to instruct the main unit 2 on display control of the objects. For example, when the user touches the sub-icon Ba, the moved object is fixed at a position after a movement. When the user touches the sub-icon Bb, the moved object returns to a position from before the movement. When the user touches the sub-icon Bc, display of the moved object disappears.

The object also returns to the position from before the movement when the user performs a flick operation in the direction in which the object was originally located.

The contents of the display control that can be instructed via the sub-icons are not limited to the above. In another example, when the user touches a sub-icon, a display range of the moved object is enlarged to a half area (half screen close to the user) or the entire area (entire screen) of the screen 13a.

When the driver drags the icon for the driver icon B3 to the edge of the screen 13a, the finger of the driver makes contact with the edge of the screen 13a. The driver, for example, may cause the sub-icons to be displayed, and move and enlarge an object via the haphazard operation of having a finger performing a drag operation make contact with the edge of the screen 13a without looking at the screen. If a physical difference in height is provided at the edge of the display unit 13, the driver can also know by tactile sensation that their finger has made contact with the edge of the screen 13a.

In the examples of FIGS. 4 and 5, the object is moved and enlarged after the sub-icons are displayed, but the processing order is not limited thereto. The sub-icon may be displayed after the object is moved and enlarged, or the object may be moved and enlarged at the same time that the sub-icon is displayed.

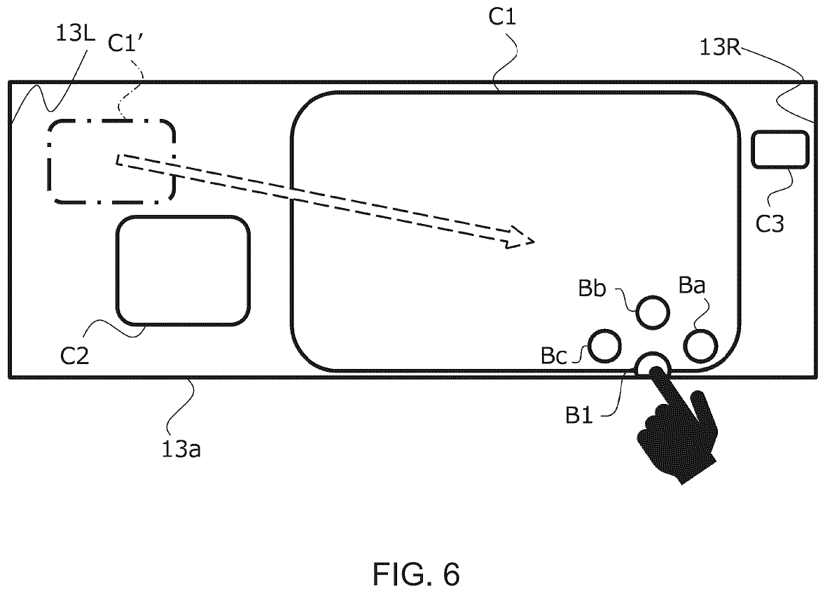

FIG. 6 is a diagram similar to FIG. 5, and illustrates an example of a display screen when a touch operation is performed on the screen 13a illustrated in FIG. 3.

As illustrated in FIG. 6, when a passenger drags the passenger icon B1 to the edge of the screen 13a (the lower end 13D of the screen 13a here), the three sub-icons Ba to Bc are displayed at positions adjacent to the dragged passenger icon B1, and the object C1 corresponding to the passenger icon B1 moves to the right end 13R side. In other words, the object C1, which is displayed at a position where it is difficult for a finger of the passenger to reach, is moved to a position where it is easy for the finger of the passenger to reach (close to the passenger icon B1 here). Note that in FIG. 6, for convenience of description, the object C1 before movement is indicated by a dashed dotted line and indicated by the reference code C1′.

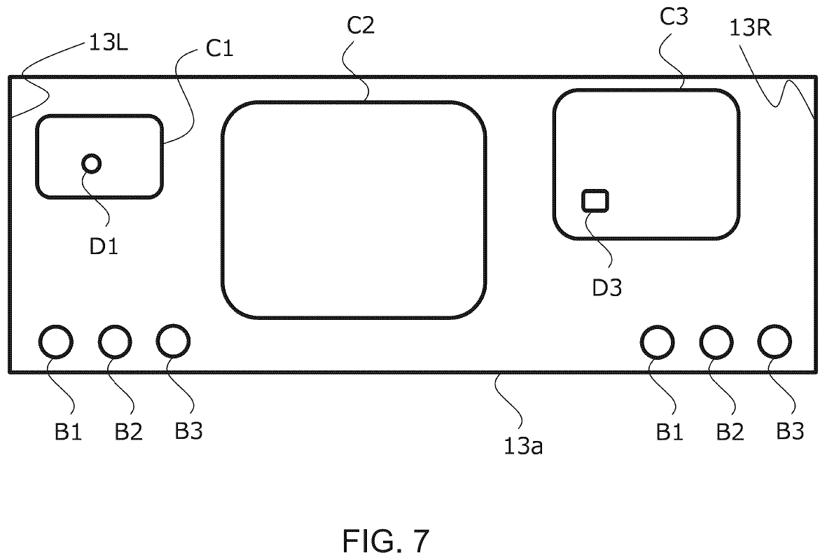

FIG. 7 illustrates an example of a display screen displayed on the screen 13a of the display unit 13.

In the example in FIG. 7, the objects C1 and C3 include information D1 and D3, respectively. In the present embodiment, the information included in the object is a component, an element, or the like included in the object. As an example, the information D1 is a component that displays facility information. The information D3 is information indicating an arbitrary point on the route set by the navigation function.

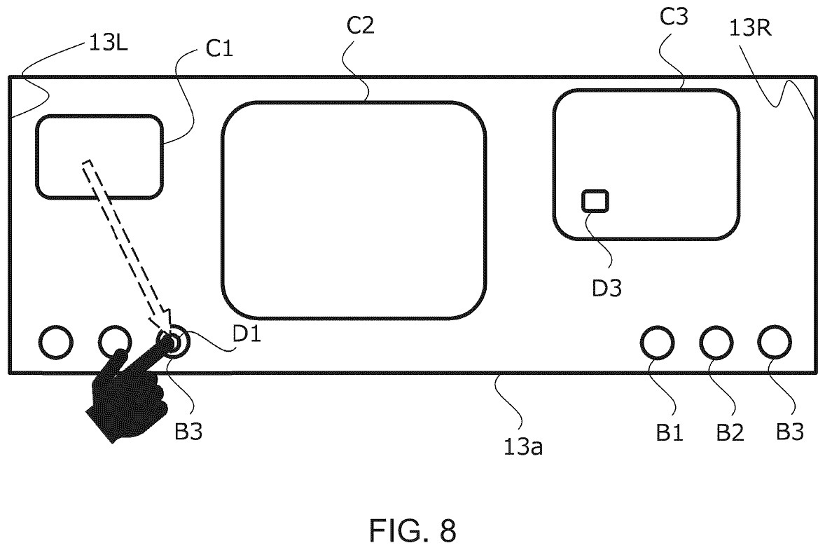

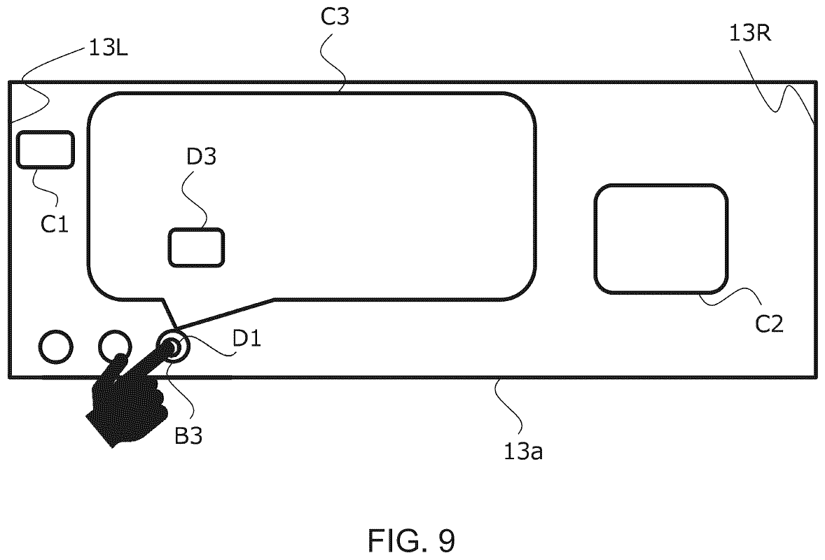

FIG. 8 and FIG. 9 illustrate examples of a display screen when a touch operation is performed on the screen 13a illustrated in FIG. 7. When the driver drags the information D1 in the object C1 to the driver icon B3 as illustrated in FIG. 8, the object C3 corresponding to the driver icon B3 moves to the left end 13L side as illustrated in FIG. 9. In other words, the object C3, which is displayed at a position where it is difficult for the finger of the driver to reach, is moved to a position where it is easy for the finger of the driver to reach (close to the driver icon B3 here).

In the example illustrated in FIG. 9, the object C3 is displayed in the form of a speech bubble coming out of the driver icon B3. Accordingly, the correspondence between the driver icon B3 and the object C3 is more clearly transmitted to the driver.

In addition, the object C3 is displayed enlarged compared to before the movement. The objects C1 and C2 other than the object C3 that corresponds to the touched driver icon B3 are reduced in size compared to before the movement of the object C3, and are evacuated to an empty space along with movement of the object C3.

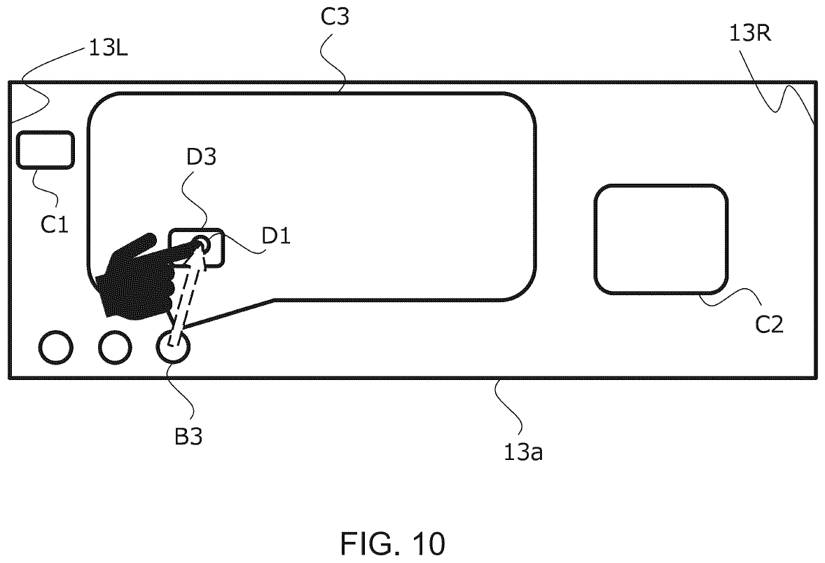

FIG. 10 illustrates an example of a display screen when a touch operation is performed on the screen 13a illustrated in FIG. 9. As illustrated in FIG. 10, when the driver drags the information D1, which is dragged onto the driver icon B3, to the information D3 in the object C3 and drops the information, processing using the information D1 and the information D3 is executed.

For example, a process of adding the information D1 (facility) as a waypoint on a route including the information D3 (arbitrary point) is executed.

In this manner, in the present embodiment, the user (driver or passenger) can easily perform an operation using information in two or more objects at a position that is easy to reach using a finger.

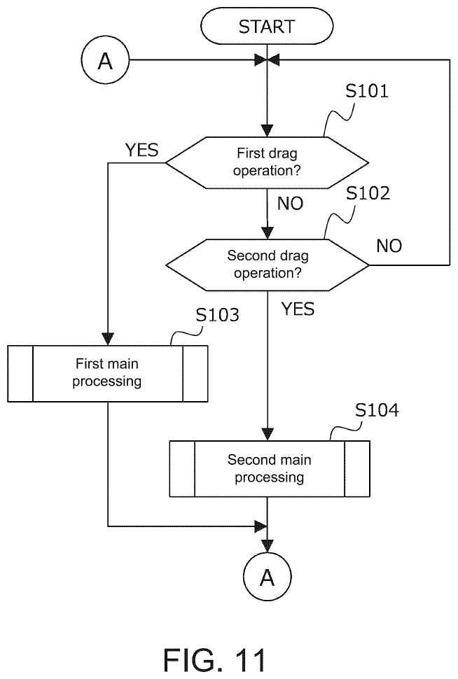

FIG. 11 is a flowchart illustrating the processing of a computer program, such as the information processing program, executed by electronic processor 10 of information processing device 2 in one embodiment of the present disclosure. For example, when the icons B are displayed on the screen 13a by the control unit 10, execution of the process illustrated in FIG. 11 is started. When the system of the in-vehicle system 1 finishes, the process illustrated in FIG. 11 finishes.

That is, before execution of the process illustrated in FIG. 11, the control unit 10 operating as an operator display control unit displays a plurality of first operators (for example, the icons B1 to B3), each corresponding to a plurality of objects (for example, the objects C1 to C3) displayed on the screen 13a, close to the left end 13L (an example of a first end of the screen) of the screen 13a and close to a right end 13R (an example of a second end of the screen opposite the first end) of the screen 13a, respectively.

Furthermore, the control unit 10, which operates as the operator display control unit, displays the plurality of first operators (for example, the icons B1 to B3) in an alignment order corresponding to the plurality of objects (for example, the objects C1 to C3) displayed on the screen 13a.

Note that the order of the steps in the flowcharts illustrated in the present embodiment may be changed as long as there is no inconsistency. Furthermore, the steps of the flowcharts shown in the present embodiment may be in parallel or in may be executed in parallel as long as there is no contradiction. For example, the present disclosure presents the processing of various steps using an example order, but such is not limited to the order presented.

The control unit 10 waits for a first drag operation (step S101) and waits for a second drag operation (step S102).

The first drag operation is an example of a first touch operation, and is an operation of dragging an icon B (an example of the first operator) displayed at a position adjacent to the edge of the screen 13a (for example, the lower end 13D of the screen 13a) to the edge.

The second drag operation is also an example of the first touch operation. The second drag operation is an operation of dragging the second information in the second object to the first operator corresponding to the first object. In the example in FIG. 8, the operation in which the driver drags the information D1 in the object C1 (an example of the second information in the second object) to the driver icon B3 (an example of the first operator corresponding to the first object) is the second drag operation.

When the control unit 10 detects the first drag operation (step S101: YES), the control unit 10 executes a first main process (step S103). When the control unit 10 detects the second drag operation (step S101: NO, step S102: YES), the control unit 10 executes a second main process (step S104).

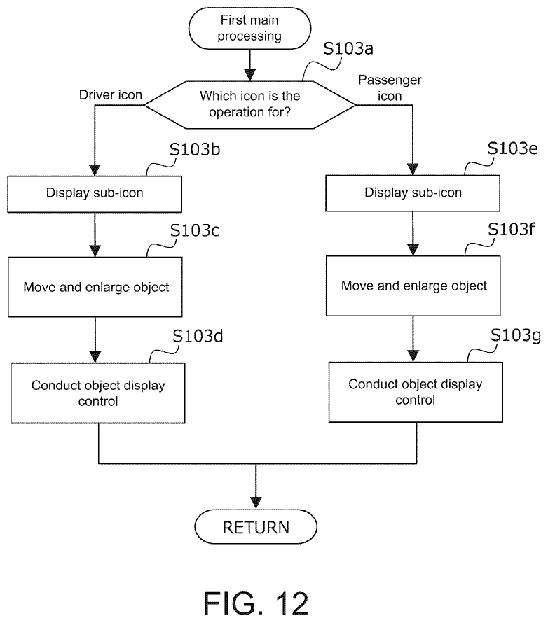

FIG. 12 is a subroutine of the first main process (step S103) in FIG. 11.

In the first main process (step S103), when the control unit 10 detects the first drag operation on the driver icon (step S103a: driver icon), the processes of step S103b and step S103c are executed.

In step S103b, the control unit 10 displays the sub-icons Ba to Bc at positions adjacent to the driver icon on which the first drag operation is performed (in other words, at positions where the finger of the driver can easily reach).

That is, the control unit 10 operating as the operator display control unit displays the sub-icons Ba to Bc (an example of a second operator) at positions adjacent to the driver icon (an example of a first operator) on which the first drag operation (an example of a first touch operation) is performed.

The driver icon is fixed at the dragged position (position touching the edge of the screen 13a). In this state, even if the finger is removed from the driver icon, the driver icon remains displayed at a fixed position, and the sub-icons Ba to Bc also remain displayed.

In step S103c, the control unit 10 moves the object corresponding to the driver icon on which the first drag operation is performed so as to approach the left end 13L of the screen 13a (in other words, so as to approach the driver side).

That is, when the first drag operation (an example of a first touch operation) is performed on the driver icon (an example of a first operator near the first end), the control unit 10 operates as an object display control unit that causes an object (an example of a first object) corresponding to the driver icon on which the first drag operation is performed to move close to the left end 13L (an example of a first end of the screen) of the screen 13a.

For example, by touching the driver icon B3 and moving the object C3 corresponding thereto to the left end 13L side, the driver can easily operate the object C3 displayed in the screen area where it is difficult for the finger to reach.

Furthermore, in step S103c, the control unit 10 displays the object corresponding to the driver icon on which the first drag operation is performed in an enlarged manner relative to other objects (see, for example, FIG. 5).

That is, the control unit 10 operating as the object display control unit enlarges and displays the object corresponding to the driver icon on which the first drag operation (an example of the first touch operation) is performed, which is moved so as to approach the left end 13L (an example of the first end) relative to the other objects.

By enlarging and displaying the object subject to operation, operability of the object is improved.

The control unit 10 performs display control of an object according to a user operation (step S103d).

For example, the control unit 10 fixes the object at the position after the movement in response to the user operation on the sub-icon Ba, returns the object to the position before the movement in response to the user operation on the sub-icon Bb, or erases the display of the object in response to the user operation on the sub-icon Bc. Next, the control unit 10 displays the driver icons B1 to B3 and the passenger icons B1 to B3, and returns to the process of step S101 in FIG. 11.

That is, when any of the sub-icons Ba to Bc are touched (when the second touch operation is performed on the second operator), the control unit 10 operating as the object display control unit performs display control according to the touched sub-icon on the object (an example of the first object) corresponding to the driver icon on which the first drag operation (an example of the first touch operation) is performed.

Since the sub-icons Ba to Bc are displayed at positions where the finger of the driver can easily reach, the driver can easily operate the display form of the object.

When the user operation is not performed for a certain period of time after the process of step S103c, for example, in step S103d, the control unit 10 returns the position and the display size of each object to the state before the first touch operation, and displays the driver icons B1 to B3 and the passenger icons B1 to B3, and returns to the process of step S101 in FIG. 11.

Upon detecting the first drag operation on the passenger icon (step S103a: passenger icon), the control unit 10 displays the sub-icons Ba to Bc (step S103e), as in steps S103b to S103d, moves and enlarges the object (step S103f), and conducts display control on the object according to a user operation (step S103g).

That is, in step S103e, the control unit 10 operating as the operator display control unit displays the sub-icons Ba to Bc (an example of a second operator) at positions adjacent to the passenger icon (an example of a first operator) on which the first drag operation (an example of a first touch operation) is performed.

In step S103f, the control unit 10 operating as the object display control unit displays the object (an example of the first object) corresponding to the passenger icon on which the first drag operation (an example of the first touch operation) is performed such that the object approaches the right end 13R (an example of the second end of the screen) of the screen 13a. In addition, in step S103f, the control unit 10 operating as the object display control unit enlarges and displays, relative to the other objects, the object corresponding to the passenger icon on which the first drag operation is performed (an example of the first touch operation) of moving closer to the right end 13R (an example of the second end).

In step S103g, the control unit 10 operating as the object display control unit performs display control according to the touched sub-icon on the object (an example of the first object) corresponding to the passenger icon on which the first drag operation (an example of the first touch operation) is performed.

In this manner, in the present embodiment, the object corresponding to the touched icons B moves to a position close to the user (driver or passenger). This allows the user to easily operate objects that were previously displayed in regions of the screen that were difficult to reach by the finger of the user.

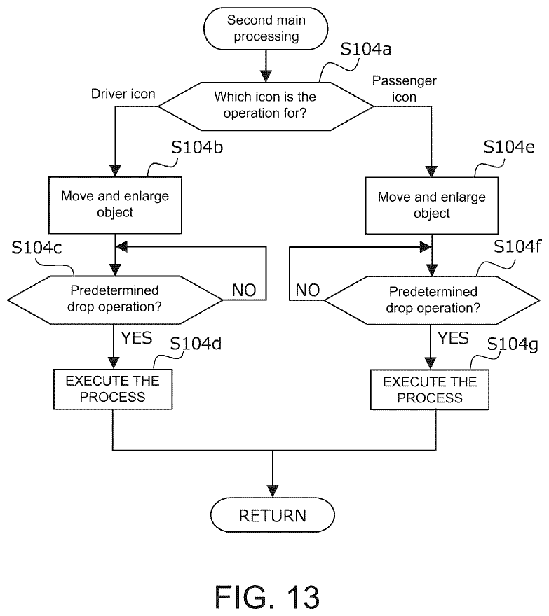

FIG. 13 is a subroutine of the second main process (step S104) of FIG. 11.

In the second main process (step S104), when the control unit 10 detects the second drag operation on the driver icon (step S104a: driver icon), for example, as illustrated in FIG. 9, the object corresponding to the driver icon at the drag destination is moved closer to the left end 13L of the screen 13a (in other words, closer to the driver side) and displayed enlarged relative to the other objects (step S104b).

The control unit 10 waits for a predetermined drop operation (step S104c).

The predetermined drop operation is an operation of dropping the second information in the second object on the first information in the first object. In the example in FIG. 9, the operation in which the driver drags the information D1, which is dragged onto the driver icon B3, to the information D3 in the object C3 and drops the information is the predetermined drop operation.

When the control unit 10 detects the predetermined drop operation (step S104c: YES), processing related to the first information in the first object is executed based on the second information in the second object (step S104d). In the example in FIG. 10, the control unit 10 executes a process of adding the information D1 (an example of the second information including the information on a facility) as a waypoint on a route including the information D3 (an example of the first information including the information on an arbitrary point).

In this way, the control unit 10 operates as a processing execution unit that executes processing related to an object. The control unit 10, which operates as a processing execution unit, executes the processing related to the first information in the first object based on the second information in the second object.

When the user operation requested by the first object is completed after the predetermined drop operation, the control unit 10 displays the driver icons B1 to B3 and the passenger icons B1 to B3 and returns to the process of step S101 in FIG. 11.

When the second drag operation on the passenger icon is detected (step S104a: passenger icon), the control unit 10 moves and enlarges the object (step S104e) and waits for a predetermined drop operation (step S104f) as in steps S104b to S104d. Upon detecting the predetermined drop operation (step S104f: YES), the control unit 10 executes the processing related to the first information (step S104g).

In this manner, in the present embodiment, the user (driver or passenger) can easily perform an operation using information in two or more objects at a position that is easy to reach using a finger.

The present embodiment is described using an in-vehicle system as an example, however, for example, the present embodiment can also be applied to an environment in which two users positioned at opposite ends of the large screen conduct operation together when working in an office, giving a presentation in a conference room, or playing a game in a living room.

The description provided thus far is a description of exemplary embodiments of the present disclosure. The embodiments of the present disclosure are not limited to those described above, and various modifications are possible within the scope of the technical concept of the present disclosure. For example, appropriate combinations of embodiments and the like that are explicitly indicated by way of example in the specification or obvious embodiments and the like are also included in the embodiments of the present application.

### DESCRIPTION OF REFERENCE NUMERALS

1: In-vehicle system
2: Main unit
10: Control unit
11: Player
12: Sound system
13: Display unit
14: Operating unit
15: Storage unit
16: GNSS reception unit
17: DR Sensor

1. An information processing device, comprising:
an operator display control unit that displays a plurality of first operators corresponding to each of a plurality of objects displayed on a screen, near a first end of the screen and near a second end of the screen opposite the first end; and
an object display control unit that, when a first touch operation is performed on the first operator near the first end, moves the first object corresponding to the first operator on which the first touch operation is performed closer to the first end, and when the first touch operation is performed on the first operator near the second end, moves the first object closer to the second end.

2. The information processing device according to claim 1, wherein the operator display control unit displays a second operator at a position adjacent to the first operator on which the first touch operation is performed when the first touch operation is performed on the first operator, and the object display control unit performs display control corresponding to the second operator on the first object when a second touch operation is performed on the second operator.

3. The information processing device according to claim 2, wherein the first operator is displayed at a position adjacent to the edge of the screen, and the first touch operation is an operation of dragging the first operator to the edge.

4. The information processing device according to claim 1, wherein the object display control unit enlarges the first object moving closer to the first end or the second end relative to other objects.

5. The information processing device according to claim 1, wherein the operator display control unit displays the plurality of first operators in an order corresponding to the plurality of objects displayed on the screen.

6. The information processing device according to claim 1, further comprising a processing execution unit that executes processing related to the objects, wherein:
the first touch operation is an operation of dragging second information within a second object to the first operator corresponding to the first object, and
the processing execution unit executes processing related to the first information based on the second information when the operation of dropping the second information onto the first information within the first object is performed.

7. The information processing device according to claim 1, wherein the information processing device is installed in a vehicle, a row of seats including a first seat located near the first end and a second seat located near the second end is installed in the vehicle, and the screen is positioned in front of the row of seats and extends in the width direction of the vehicle.

8. A non-transitory, computer-readable recording medium having stored thereon a computer program that, when executed by an electronic processor of an information processing device, configures the information processing device to execute a process comprising:
respectively displaying, close to a first end of a screen and a second end of the screen opposite the first end, a plurality of a first operator corresponding to each of a plurality of objects displayed on the screen;
moving, when a first touch operation is performed on the first operator close to the first end, a first of the objects corresponding to the first operator on which the first touch operation is performed closer to the first end; and
moving, when the first touch operation is performed on the first operator close to the second end, the first object closer to the second end.
